(19) United States
(12) Patent Application Publication
(10) Pub. No.: US 2014/0171529 A1
(43) Pub. Date: Jun. 19, 2014

(54) ANTIMICROBIAL BIO POLYURETHANE FOAM

(71) Applicants: Hyundai Dymos Incorporated, Seosan (KR); Hyundai Motor Company, Seoul (KR)

(72) Inventors: Seok-Hwan Kim, Gunpo (KR); Hyung-Won Jeon, Daegu (KR); Jun-Ho Song, Seoul (KR); Jeong-Seok Oh, Yongin (KR)

(73) Assignees: HYUNDAI DYMOS INCORPORATED, Seosan (KR); HYUNDAI MOTOR COMPANY, Seoul (KR)

(21) Appl. No.: 14/103,059

(22) Filed: Dec. 11, 2013

(30) Foreign Application Priority Data
Dec. 14, 2012 (KR) 10-2012-0146576
Jul. 2, 2013 (KR) 10-2013-0077320

(51) Int. Cl. C08G 18/68

(52) U.S. Cl. CPC C08G 18/68
USPC 521/122; 521/172

(57) ABSTRACT

Disclosed is an antimicrobial bio polyurethane foam, and more specifically abio polyurethane foam: which is polyurethane foam comprising a reaction product of a resin premix, which comprises biopolyol of about 5 to 20 wt %, and isocyanate; applied to a car seat and the like; and which is enhanced in an antimicrobial property through use of the biopolyol.

### CROSS-REFERENCE TO RELATED APPLICATION

The present application claims priority to Korean Patent Application No. 10-2012-0146576, filed on Dec. 14, 2012 and No. 10-2013-0077320, filed on Jul. 2, 2013, the entire contents of which is incorporated herein for all purposes by this reference.

### BACKGROUND

(a) Technical Field

The present invention relates topolyurethane foam, and more specifically, to polyurethane foam, which is suitable for application to a car seat and the like, and which is enhanced in an antimicrobial property.

(b) Background Art

Due to the continuous increase of international crude oil prices, there is crisis in petrochemical industries that depending upon petroleum resources. Further, regulations on greenhouse gas emissions are continually being strengthened due to global warming caused by the consumption of petroleum resources. Thus, active studies are underway for lowering the degree of dependence upon petroleum resources, including, for example, biotechnology studies.

Herein, the biotechnology studies refer to a technology using biomass, which is repeatedly produced by photosynthesis of plants in the natural world, as a raw material. Such studies, unlike the previous chemical industry-based technologies which depend on 0fossil materials such as petroleum resources, can include new bio-chemistry fused-type technologies, which can provide sustainable growth and survival of the human race by replacing a portion or many portions of the previous chemical industries.

When comparing the greenhouse gas emissions of the products using the petrochemical materials and bio materials in terms of environmental pollution, the petrochemical material-based products go through processes of petrochemical purification, transfer of the purified material, production of products, transfer of the produced products, and then discarding of the products. In these processes, a significant amount of greenhouse gas is particularly emitted during the processes of petrochemical purification, and the production and the discarding of the products.

On the other hand, the bio material-based products go through processes of plant growth, transfer of the plant-based raw materials, reduction of greenhouse gas, transfer, and biodegradation and discarding of the products. In these processes the greenhouse gas is absorbed during the production of the raw materials, and is reduced during the production and the discarding of the products. Accordingly, the bio material-related technologies are of growing importance in terms of effectively responding to a carbon tax scheme according to carbon dioxide reduction, improvement of products' competitiveness and the prime cost increase of the petroleum resources.

This bio material-based technologies are continuing to make progress in the midst of a paradigm shift of the 21^{st} century-type chemical industries, which are seeking more eco-friendly and sustainable growth, and particularly in light of trends of the chemical industries towards the development and production of bio-plastics using the biomass as a raw material. Such trends address the needs of cost reduction and protection of the environment.

Particularly, various kinds of vegetable oil-based biopolyols are being developed in a variety of countries based on the available vegetable raw materials. In particular, various kinds of biopolyols, for example soybean oil-based polyols in the United States, palm oil-based polyols in Malaysia, castor oil and sunflower oil-based polyols in Europe, have been developed and are being marketed.

However, the polyols applied to a car seat and the like are required to have higher molecular weight than that provided by most of the vegetable oils (vegetable oil-based biopolyols), which generally have lower molecular weight than the conventional polyol. Accordingly, when the vegetable oil-based biopolyols were applied to the polyurethane foam for the car seat and the like, there was a problem of breakdown of the foam or deterioration of physical properties due to unreacted materials contained in the biopolyols.

Further, when conducting a chemical process to remove the unreacted materials contained in the biopolyols, there were problems in that the production cost was increased by the additional chemical process, and the advantage of reduction of greenhouse gas emissions by using the bio materials was eliminated by addition of the chemical process.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the above-described problems associated with prior art. In particular, the present invention provides antimicrobial bio polyurethane foam, which is enhanced in antimicrobial effect and which further provides the same level of shape and physical properties as polyurethane foam manufactured by a polymerization reaction using a conventional petroleum-based polyol.

According to one aspect, an antimicrobial bio polyurethane foam according to the present invention is polyurethane foam comprising a reaction product of a resin premix and isocyanate, wherein the resin premix comprises a biopolyol in an amount of about 5 to 20 wt %.

As the isocyanate, any conventional isocyanates can be used in suitable amounts. According to a preferred embodiment the isocyanate is methylene diphenyldiisocyanate(MDI).

Further, the boipolyol can be manufactured from any vegetable raw material. According to one embodiment of the present invention, it is preferred that the biopolyol is manufactured from castor oil or soybean oil.

According to a preferred embodiment, the resin premix further comprises a base polyol, a high molecular polyol and a polymer polyol in suitable amounts. According to various embodiments, the resin premix includes a base polyol in an amount of about 5 to 40 wt %, a high molecular polyol in an amount of about 15 to 55 wt % and polymer polyol in an amount of about .3 to 40 wt %.

With respect to molecular weight, it is preferred that molecular weight (MW) of the biopolyol is about 2500 to 3500, the molecular weight (MW) of the base polyol is about 5000 to 6000, and the, molecular weight (MW) of the high molecular polyol is about 6500 to 7500. These polyols may be any conventional polyols, and in a preferred embodiment, the base polyol and the high molecular polyolare selected from polyether polyols, polyester polyols and combinations thereof.

According to various embodiments, it is preferred that the resin premix further comprises a chain extender, a cross-linker, and/or a silicone surfactant. Any conventional chain extenders, cross-linkers, and silicone surfactants can be used in suitable amounts. According to an exemplary embodiment, a chain extender is added in an amount of about 0.1 to 1 wt %, a cross-linker in an amount of more than 0 to less than about5 wt %, and a silicone surfactant in an amount of about 0.1 to 3 wt %.

According to an exemplary embodiment of the present invention, the silicone surfactant comprises a first silicone surfactant and a second silicone surfactant, the second silicone surfactant having relatively stronger activity than the first silicone surfactant.

According to various embodiments, the resin premix further comprises a blowing agent, a gelling catalyst, and/or a blowing catalyst in suitable amounts. According to an exemplary embodiment, the resin premix includes a blowing agent in an amount of about 1 to wt %, a gelling catalyst in an amount of about 0.1 to 3 wt %, and a blowing catalyst in an amount of about 0.1 to 3 wt %.

According to a further aspect, the present invention provides an antimicrobial bio polyurethane foam that can be applied to manufacture of a car seat, and a car seat thus manufactured.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is a picture showing a conventional biopolyol-based polyurethane foam comprising biopolyol of 10 wt % based on weight of a resin premix;

FIG. 2 is a picture showing a conventional biopolyol-based polyurethane foam comprising biopolyol of 20 wt % based on weight of a resin premix;

FIG. 3 is a picture showing a conventional biopolyol-based polyurethane foam comprising biopolyol of 30 wt % based on weight of a resin premix;

FIG. 4 is a picture showing polyurethane foam manufactured by using a resin premix having the composition of Comparative Example 1 and isocyanate in accordance with an embodiment of the present invention;

FIG. 5 is a picture showing polyurethane foam manufactured by using a resin premix having the composition of Example 1 and isocyanate in accordance with an embodiment of the present invention; and

FIG. 6 is a picture showing polyurethane foam manufactured by using a resin premix having the composition of Example 2 and isocyanate in accordance with an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terms and the words used in the specification and claims should not be construed with common or dictionary meanings, but construed as meanings and conception coinciding the spirit of the invention based on a principle that the inventors can appropriately define the concept of the terms to explain the invention in the optimum method. Therefore, embodiments described in the specification and the configurations shown in the drawings are not more than the most preferred embodiments of the present invention and do not fully cover the spirit of the present invention. Accordingly, it should be understood that there may be various equivalents and modifications that can replace those when this application is filed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, present invention now will be described in detail with reference to the accompanying drawings,

According to a first aspect, the present invention relates to antimicrobial bio polyurethane foam, which is enhanced in an antimicrobial function by using castor oil-based or soybean oil-based biopolyol.

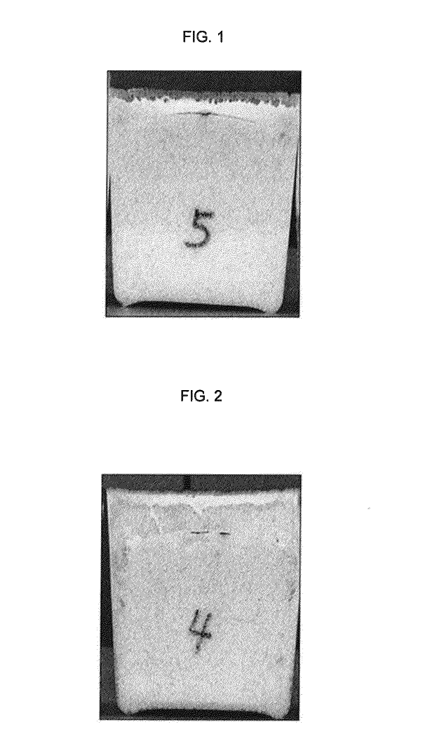

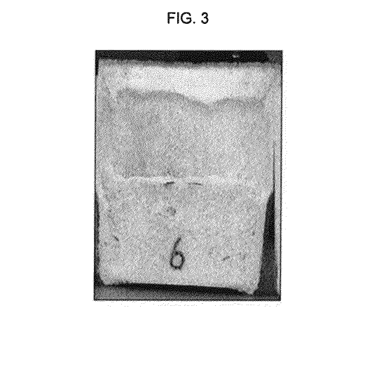

FIG. 1 to FIG. 3 are pictures showing conventional biopolyol-based polyurethane foams comprising abiopolyol of 10 wt %, 20 wt % and 30 wt % based on weight of the resin premix, respectively. As shown therein, as the amount of the biopolyol increases, unreacted material contained in the biopolyol also increase, thereby resulting in severe breakdown of the foam and reduction of physical properties,

As one example, a castor oil-based biopolyol comprises ricinoleic acid as a major ingredient, and further comprises stearic acid, linoleic acid, oleic acid and the like. The ingredients other than the ricinoleic acid exist as unreacted materials and thereby prevent formation of normal foam.

To solve this problem, the present invention provides antimicrobial bio polyurethane foam embodying enhanced antimicrobial effect by the unreacted materials. Further, the antimicrobial bio polyurethane foam of the present invention is provided with the same level of shape and physical properties as the conventional petroleum polyol-based polyurethane foam. The present invention accomplishes this by providing a reaction product of a resin premix, which comprises high molecular polyol, a cross-linker, a chain extender, a highly active silicone surfactant and the like, and isocyanate.

In particular, the present invention provides a polyurethane foam comprising the reaction product of the resin premix and the isocyanate. In various embodiments, the resin premix can further comprise about 5 to 20 wt % biopolyol based on weight of the resin premix, other polyols and/or additives.

The isocyanate can be any conventional isocyanate. In preferred embodiments, the isocyanate is methylene diphenyldiisocyanate(MDI) or toluenediisocyanate(TDI) and the like. It is preferred to use methylene diphenyldiisocyanate(MDI) as aromatic diisocyanates. The MDI is largely classified into MDI monomers and polymeric MDI, and the MDI monomer may comprises an isomer such as 2,2′-MDI, 2,4′-MDI and 4,4′-MDI.

(A) Biopolyol

As referred to herein, the biopolyol means a polyol manufactured by using vegetable oil extracted from seeds or fruits of various plants, animal oil from various kinds of fish-based oil, and the like. Thus, biopolyols are distinct from polyether polyol or polyester polyol manufactured from a raw petrochemical material. Preferably, the biopolyol used in the present invention has a molecular weight (MW) of about 2500 to 3500.

According to various embodiments, the biopolyol according to the present invention is manufactured from a vegetable oil, which has an eco-friendly effect, and can be manufactured by any common known method. Preferably, the vegetable oils at least one selected from the group consisting of castor oil, soybean oil, palm oil, canola oil and sunflower oil. In particular, as can be confirmed by the examples below, oils with antimicrobial effect such as castor oil or soybean oil are the most preferable.

The biopolyolis preferably contained in an amount of about 5 to 20 wt % based on weight of the resin premix. When the amount is less than about 5 wt %, the effect obtained by adding the biopolyol, (i.e., reduction of greenhouse gas emissions and the antimicrobial effect, which will be mentioned below), may be meager. On the other hand, when the amount of biopolyol excesses about 20 wt %, the foam may be hardly formed, and physical properties may be deteriorated. Accordingly, it is preferred to satisfy the said range.

According to various embodiments, it is preferred that the resin premix further comprises the base polyol in an amount of about 5 to 40 wt %, the high molecular polyol in an amount of about 15 to 55 wt % and the polymer polyolin an amount of about 3 to 40 wt %.

(B) Base Polyol

Are referred to herein, the base polyol means the conventional petroleum-based polyols and commonly known polyols. Such base polyols can be added to the polyurethane foam, and include, for example, polyether polyol, polyester polyol and combinations thereof. Preferably, the base polyol has a molecular weight (MW) of about 5000 to 6000.

It is preferred to add the base polyol in an amount of about 5 to 40 wt % based on weight of the resin premix. When the amount is less than about 5 wt %, there may be a problem of increase of vibration transmissivity. On the other hand, when the amount exceeds about 40 wt %, compression permanent decrease rate may be deteriorated. Accordingly, it is preferred to satisfy the said range.

(C) High Molecular Polyol

As referred to herein, the high molecular polyol means any commonly known polyols. Such high molecular polyols, which are applied to the polyurethane foam, and can be, for example, polyether polyol, polyester polyol and combinations thereof (like the base polyol). In order to improve resilience and elongation rate of the formed foam, it is preferred that the high molecular polyol have a molecular weight (MW) greater than that of the base polyol, such as, for example, about 6500 to 7500.

It is preferred to contain this high molecular polyol in an amount of about 15 to 55 wt % based on weight of the resin premix. When the amount is less than about 15 wt %, the resilience may be significantly reduced. On the other hand, when the amount of high molecular polyol exceeds about 55 wt %, the resilience may increase, and comfort of the soft polyurethane foam may be deteriorated. Accordingly, it is preferred to satisfy the said range.

(D) Polymer Polyol

The polymer polyol is also called a copolymer polyol, and is used for improving hardness and the like by mixing with the base polyol.

It is preferred to contain the polymer polyol in an amount of about 3 to 40 wt % based on weight of the resin premix. When the amount is less than about 3 wt %, the hardness may be significantly decreased, thereby the applicable uses for f the polyurethane foam may become more narrow. On the other hand, when the amount of polymer polyol exceeds about 40 wt %,the hardness may increase, and the comfort of the soft polyurethane foam may be deteriorated. Accordingly, it is preferred to satisfy the said range.

According to various embodiments, it is preferred that the resin premix further comprises a chain extender, a cross-linker, and/or a silicone surfactant. According to exemplary embodiments, the resin premix further comprises chain extender in an amount of about 0.1 to 1 wt %, a cross-linker in an amount of more than 0 to less than about 5 wt %, and a silicone surfactant in an amount of about 0.1 to 3 wt %.

(E) Chain Extender and Cross-Linker

The chain extender and the cross-linker are reactive monomers used for enhancing intermolecular bonding, and any conventional such materials can be used. In particular, the chain extender plays a role of extending a main chain, and it may be mainly bivalent alcohols or amines. The cross-linker plays a role of making the chains form a mesh structure or branched structure in order to prevent the breakdown of the foam and to improve tensile strength, dry set and the like, and it may be mainly trivalent alcohols or amines.

In one exemplary embodiment of the present invention, the chain extender is 1,4-butane diol (OH—V=500˜1500 mg KOH/g), and the cross-linker is triethanolamine.

Further, it is preferred to contain the chain extender in an amount of about 0.1 to 1 wt % based on weight of the resin premix. When the amount is less than about 0.1 wt %, the effect of extending the main chain may be meager. On the other hand, when the amount exceeds about 1 wt %, fluidity may be deteriorated. Accordingly, it is preferred to satisfy the said range,

Further, it is preferred to contain the cross-linker in an amount of more than 0 to less than about 5 wt % based on weight of the resin premix. When the amount exceeds to about 5 wt %, the fluidity may be deteriorated, thereby increasing the defect rate. Accordingly, it is preferred to satisfy the said range,

(F) Silicone Surfactant

The silicone surfactant plays roles of making the mixing of raw materials easier (emulsification), helping bubble growth by lowering surface tension of a urethane system, and preventing gas diffusion by lowering pressure difference between bubbles. According to preferred embodiments, the present antimicrobial bio polyurethane foam contains a first silicone surfactant and a second silicone surfactant as set forth below.

TABLE 1

| | First Silicone | Second Silicone |
|---|---|---|
| | Surfactant | Surfactant |
| Silicone Polymer MW | Low | High |
| Branched Polyether | Low | High |
| Branched Polyethylene | High | Low |
| Ethyleneoxide (PE EO) | | |

The Table 1 is a table comparing the first silicone surfactant and the second silicone surfactant used in the present invention. The first silicone surfactant refers to a silicone surfactant typically used in a polyurethane foam manufactured from the conventional petroleum-based polyol. The second silicone surfactant is a material optionally added together with the first silicone surfactant and having a stronger activity than the first silicone surfactant. Addition of the second silicone surfactant has an effect of effectively preventing breakdown of the foam caused by addition of the biopolyol due to its stronger activity than the first silicone surfactant.

According to a preferred embodiment, the foam of the present invention contains a silicone surfactant, comprising the first silicone surfactant and the second silicone surfactant, in an amount of about 0.1 to 3 wt % based on weight of the resin premix. When the amount is less than about 0.1 wt %, the urethane foam may be hardly formed. On the other hand, when the amount exceeds about 3 wt %, the productivity may be deteriorated by overproduction of closed cells. Accordingly, it is preferred to satisfy the said range.

According to various embodiments, it is preferred that the resin premix further comprises a blowing agent, a gelling catalyst, and/or a blowing catalyst, particularly about 1 to 5 wt % of a blowing agent, about 0.1 to 3 wt % of a gelling catalyst, and about 0.1 to 2 wt % of a blowing catalyst.

(G) Blowing Agent

The blowing agent is a material used for manufacturing foam and plays a role of forming bubbles during polymer reaction. Any conventional blowing agents can suitably be used.

It is preferred to contain the blowing agent in an amount of about 1 to 5 wt % based on weight of the resin premix. When the amount is less than about 1 wt %, blowing rate may be lowered, thereby formation of the foam may be difficult. On the other hand, when the amount exceeds about 5 wt %, physical properties may be deteriorated by over blowing. Accordingly, it is preferred to satisfy the said range,

(H) Gelling Catalyst and Blowing Catalyst

The gelling catalyst is a catalyst for accelerating the reaction of the polyol and the isocyanate. Any conventional gelling catalysts can be used, and, according to preferred embodiments, it may be selected from organic metals (tin compound, lead compound and the like), a part of tertiary amines (TEDA) and the like. The blowing catalyst is a catalyst for accelerating saturation reaction of the isocyanate and water. Any conventional blowing catalysts can be used, and, according to preferred embodiments, it may be a part of tertiary amines (PMDETA, BDMEE) and the like.

According to various embodiments, it is preferred to contain the gelling catalyst in an amount of about 0.1 to 3 wt % based on weight of the resin premix. When the amount is less than about 0.1 wt %, productivity may be deteriorated by lowered curing property. On the other hand, when the amount exceeds about 3 wt %, the fluidity may be deteriorated, thereby porosity may be poor. Accordingly, it is preferred to satisfy the said range.

According to various embodiments, it is preferred to contain the blowing catalyst in an amount of about 0.1 to 2 wt % based on weight of the resin premix. The reasons for limiting the upper limit and the lower limit are same as the gelling catalyst

The polyurethane foam having the composition according to the present invention is eco-friendly and expresses excellent antimicrobial property as well as showing the same level of physical properties as the conventional petroleum-based polyol. Accordingly, it can be applied to manufacture of a car seat and the like,

### EXAMPLE 1

Hereinafter, the present invention will be described in further detail with reference to examples. It will be obvious to a person having ordinary skill in the art that these examples are illustrative purposes only and are not to be construed to limit the scope of the present invention.

TABLE 2

| | Comparative | | |
|---|---|---|---|
| | Example 1 | Example 1 | Example 2 |
| | (wt %) | (wt %) | (wt %) |
| Base Polyol | 66.66 | 18.64 | 18.44 |
| Bio Polyol | — | 18.64 | 19.54 |
| High Molecular Polyol | — | 27.96 | 27.96 |
| Polymer Polyol | 28.57 | 27.96 | 27.96 |
| Blowing Catalyst | 0.29 | 0.28 | 0.28 |
| Gelling Catalyst | 0.67 | 0.65 | 0.65 |
| Cross-linker | — | 0.65 | 0.40 |
| Chain Extender | — | 1.40 | 1.1 |
| First Silicone Surfactant | 0.95 | 0.74 | 0.64 |
| Second Silicone Surfactant | — | 0.28 | 0.17 |
| Blowing Agent | 2.86 | 2.80 | 2.86 |

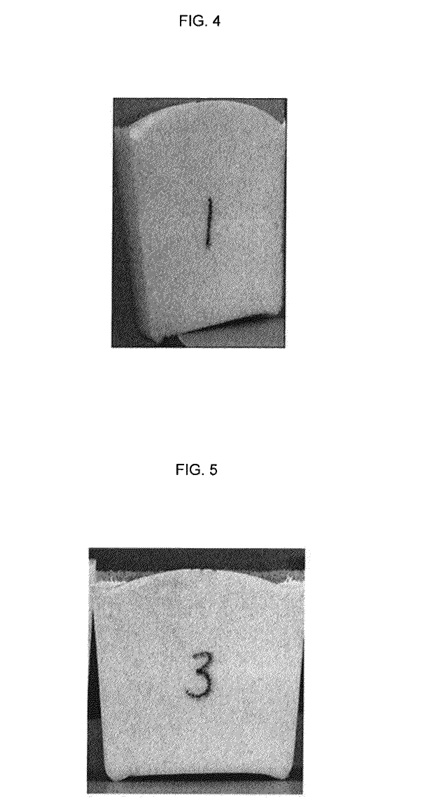

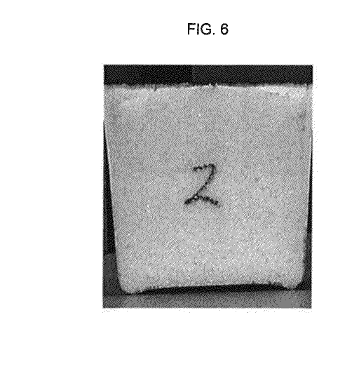

The above Table 2 is a table showing the compositions of the polyurethane foam manufactured from the conventional petroleum-based polyol (Comparative Example 1), the polyurethane foam based on the biopolyol manufactured by castor oil according to the present invention (Example 1), and the polyurethane foam based on the biopolyol manufactured by soybean oil according to the present invention (Example 2) The polyurethane foams were manufactured by common known reactions by using the resin premix having the said composition and the isocyanate, and pictures of Comparative Example 1, Example 1, and Example 2 results are illustrated in FIG. 4, FIG. 5 and FIG. 6 respectively.

TABLE 3

| | Comparative | | |
|---|---|---|---|
| | Example 1 | Example 1 | Example 2 |
| Hardness (ILD) | 26.2 | 26.0 | 27.2 |
| Resilience | 65 | 65 | 60 |
| Tensile | 1.7 | 1.7 | 1.5 |
| Elongation Rate | 120 | 122 | 118 |
| Dry Heat Compression | 10 | 9 | 11 |
| Permanent Deformation | | | |
| (Dry set, 80° C., 75% m 22 hr) | | | |

As shown in Table 3, it was demonstrated that, although the polyurethane foam based on the biopolyol manufactured by castor oil or soybean oil according to the present invention contained the biopolyolin an amount of up to 20 wt % relative to the resin premix, it showed the same level of shape and physical properties as the polyurethane foam manufactured from the conventional petroleum-based polyol.

In addition, the antimicrobial effect of the polyurethane foam according to the present invention was enhanced by the unreacted materials, except the ricinoleic acid, etc., in the biopolyol. Accordingly, it will be observed in further detail below.

TABLE 4

| | | | Compara- | | |
|---|---|---|---|---|---|
| | | | tive | Exam- | Exam- |
| Section | | Blank | Example 1 | ple 1 | ple 2 |
| Staphylo- | Initial | 2.0 × 10\hat{ }4 | 2.0 × 10\hat{ }4 | 2.0 × 10\hat{ }4 | 3.0 × 10\hat{ }4 |
| coccus | Bacteria | | | | |
| aureus | Number/ | | | | |
| | ml | | | | |
| | 18 hrs | 2.2 × 10\hat{ }6 | 1.3 × 10\hat{ }6 | 1.6 × 10\hat{ }4 | 2.0 × 10\hat{ }2 |
| | later/ | | | | |
| | ml | | | | |
| | Bacteria | — | 40.9% | 99.3% | 99.9% |
| | Ruction | | | | |
| | Rate | | | | |
| Klebsiella | Initial | 2.5 × 10\hat{ }4 | 2.5 × 10\hat{ }4 | 2.5 × 10\hat{ }4 | 2.0 × 10\hat{ }4 |
| pneumoniae | Bacteria | | | | |
| | Number/ | | | | |
| | ml | | | | |
| | 18 hrs | 1.6 × 10\hat{ }6 | 8.5 × 10\hat{ }6 | 8.3 × 10\hat{ }4 | 2.9 × 10\hat{ }3 |
| | later/ml | | | | |
| | Bacteria | — | 46.9% | 48.1% | 99.9% |
| | Ruction | | | | |
| | Rate | | | | |

The above Table 4 is a table comparing the antimicrobial effect of the polyurethane foam manufactured from the conventional petroleum-based polyol (Comparative Example) and the polyurethane foam based on the biopolyol manufactured by castor oil according to the present invention (Example 1) and the polyurethane foam based on the biopolyol manufactured by soybean oil according to the present invention (Example 2). In particular, the number of bacteria were measured after injecting solutions containing Staphylococcus aureus(ATCC 6538) and Klebsiella pneumoniae(ATCC 4352) in an amount of 0.2 cc, respectively, to a sample followed by maintaining at 37° C. for 18 hours.

(Test Institute: FITI testing and research institute, Test Standard KS K 0693-2006 antibacterial activity)

As shown in the above table, it was confirmed that the polyurethane foam according to the present invention showed significantly improved antimicrobial effect as compared to the conventional polyurethane foam. This improvement was caused by the unreacted materials in the biopolyol. It was further found that the physical properties of the foam were maintained even though the unreacted materials were in the biopolyol, and the antimicrobial function was enhanced by the unreacted materials.

The polyurethane foam according to the present invention having the constitution described above is has an effect of showing the same level of shape and physical properties as the polyurethane foam manufactured from the petroleum-based polyolby improving the defect of the conventional polyol-based biopolyol polyurethane foam.

Further, the present polyurethane foam has an advantage of showing excellent antimicrobial properties such as reducing Staphylococcus aureusor Klebsiella pneumonia by the unreacted materials contained in the biopolyol.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. Antimicrobial bio polyurethane foam comprising a reaction product of a resin premix and isocyanate, wherein the resin premix comprises a biopolyol in an amount of about 5 to 20 wt %.

2. The antimicrobial bio polyurethane foam according to claim 1, wherein the isocyanate is methylene diphenyldiisocyanate(MDI).

3. The antimicrobial bio polyurethane foam according to claim 1, wherein the biopolyol is manufactured from castor oil or soybean oil

4. The antimicrobial bio polyurethane foam according to claim 1, wherein the resin premix further comprises a base polyol in an amount of about 5 to 40 wt % a high molecular polyol in an amount of about 15 to 55 wt % and a polymer polyol in an amount of about 3 to 40 wt %.

5. The antimicrobial bio polyurethane foam according to claim 4, wherein molecular weight (MW) of the biopolyol is about 2500 to 3500, molecular weight (MW) of the base polyol is about 5000 to 6000, and molecular weight (MW) of the high molecular polyol is about 6500 to 7500.

6. The antimicrobial bio polyurethane foam according to claim 4, wherein the base polyol and the high molecular polyol is selected the group consisting of polyether polyol, polyester polyol and a combination thereof.

7. The antimicrobial bio polyurethane foam according to claim 4, wherein the resin premix further comprises a chain extender in an amount of about 0.1 to 1 wt %, a cross-linker in an amount of more than 0 to less than about 5 wt %, ands silicone surfactant in an amount of about 0.1 to 3 wt %.

8. The antimicrobial bio polyurethane foam according to claim 7, wherein the silicone surfactant comprises a first silicone surfactant and a second silicone surfactant, the second silicone surfactant having relatively stronger activity than the first silicone surfactant.

9. The antimicrobial bio polyurethane foam according to claim 7, wherein the resin premix further comprises a blowing agent in an amount of about 1 to 5 wt %, a gelling catalyst in an amount of about 0.1 to 3 wt %, and a blowing catalyst in an amount of about 0.1 to 3 wt %.

10. A car seat manufactured from the antimicrobial bio polyurethane foam according to claim 1.
